(19) United States
(12) Patent Application Publication
(10) Pub. No.: US 2006/0181090 A1
(43) Pub. Date: Aug. 17, 2006

(54) Vehicle bumper beam comprising a crosspiece and two shock absorbers

(76) Inventors: Emmanuel Boivin, Vernon (FR); Jean Philippe Ponsonnaille, Vernon (FR); Thierry Renault, Vernon (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/490,532

(22) PCT Filed: Sep. 20, 2002
(86) PCT No.: PCT/FR02/03219

§ 371 Date: Dec. 23, 2004

(30) Foreign Application Priority Data
Sep. 20, 2001 (FR) 01/12140

(51) Int. Cl. B60R 19/36

(52) U.S. Cl. 293/146

(57) ABSTRACT

The invention concerns a vehicle bumper beam comprising a crosspiece (6) and two shock absorbers (8) fixed at two respective portions of the crosspiece and made with a material different from the material of the crosspiece. The shock absorbers are made of synthetic material.

The invention relates to bumper beams for motor vehicles, in respect of both front bumpers and rear bumpers.

It is known that the behavior of vehicle bumpers in the event of impact can be studied by means of various tests that are more or less standardized as a function in particular of the regulations in force in Europe and the United States of America. There are essentially four of these tests.

Firstly, there is the test known as the “parking impact” test. It is carried out at four kilometers/hour in Europe and at eight kilometers/hour in the United States of America. During this test, only the bumper absorber should deform without damaging the bumper beam itself.

Another of these tests is that known as the “pedestrian impact” test. It aims to as far as possible reduce the injuries caused to a pedestrian when struck by a vehicle at low speed.

Another of these tests is that known as the “urban impact” test. In Europe this is also referred to the as “DANNER” impact or “reparability impact” test. During this test, the vehicle strikes a solid wall at a speed of sixteen kilometers/hour, the wall extending over 40% of the width of the vehicle. During this impact, the bumper must be primarily damaged so as to preserve the chassis of the vehicle, in particular the side rails.

Finally, the fourth test is that known as the “high speed impact compatibility” test. During this test, the vehicle strikes a barrier that covers 40% of the width of the vehicle, at a speed of sixty kilometers/hour. This standardized barrier comprises a deformable buffer stop made of aluminum with a honeycomb structure of 50 psi (compression pressure), this buffer stop being followed by a wall having a honeycomb structure also of 50 psi. During this impact, the bumper beam mounted on the side rails of the vehicle must be capable of deforming the barrier uniformly without breaking the latter. It is particularly important that the side rail of the vehicle does not break the barrier. The beam must not break and must deform the barrier so that it does not bear against the engine. It is therefore necessary that the beam deforms the buffer stop, starts to deform the barrier and, without breaking the beam and during crushing of the barrier, the side rail itself begins to be crushed. Once the beam is bearing against the engine, it is considered that it has performed its function. In order not to perforate the barrier with the side rail, the force has to be distributed over the entire bearing surface of the beam. It is also necessary to prevent the beam from wrapping itself around the barrier. In order to successfully pass this test, the beam must be rigid so as to distribute the forces over the barrier.

In this context, bumper beams made of steel or aluminum have been proposed. However, steel beams prove to be very heavy whereas aluminum beams are relatively expensive.

Beams made of composite material based on a plastic possibly reinforced with glass fibers have also been proposed. However, these beams generally are not sufficiently resistant to impact. They break into a number of pieces or else are not sufficiently rigid to deform the barrier in the event of a high-speed impact.

There has also been proposed a beam formed of an aluminum profiled part and two steel absorbers which are designed to be fixed to the side rails of the vehicle and to be compressed in the event of an impact of the “reparability impact” type. The use of aluminum in such a beam makes it possible to reduce its weight. Moreover, steel absorbers are inexpensive to mould and have a compression ratio that is greater than they would have if they were to be made of aluminum. However, this beam is still relatively heavy and the absorbers are still relatively voluminous.

One object of the invention is to provide a bumper beam which responds well during the various impacts mentioned above and does so without having either a prohibitive weight or a prohibitive volume or a prohibitive cost.

For this purpose, there is provided according to the invention a bumper beam for a vehicle, comprising one crossbar and two shock absorbers that are attached to two respective portions of the crossbar and are formed in a material that is different from a material of the crossbar, the absorbers being made of synthetic material.

Thus, absorbers made of synthetic material make it possible to reduce the weight of the beam in comparison with absorbers made of steel. This gain may be up to 50% if the absorbers are made of composite material. Moreover, the absorbers of the beam according to the invention have a compression ratio greater than that of steel, which makes it possible to reduce their volume at rest while absorbing the same amount of energy in the event of an impact. It is therefore possible to give cars a more compact style. The absorber made of synthetic material is particularly useful in the case of the “reparability impact”.

More specifically, the compression ratio corresponds to the ratio between the crushing travel of the absorber (without an increase in force greater than the resistance of the side rail) divided by the initial height of the absorber. A steel absorber operates by bundling. Once the folds of the absorber are in contact with one another, the crushing force must increase so as to continue to deform the absorber. By contrast, for a composite absorber, the deformation is progressive: the material becomes delaminated as compression continues. A steel absorber has a compaction ratio of around 75%, whereas an absorber made of synthetic or composite material has a compaction ratio of 90%. For example, for a crushing travel of 100 mm, a steel absorber will be given a height of 135 mm and an absorber made of synthetic material will be given a height of 110 mm, that is to say a gain of 25 mm, which is far from negligible in terms of motor car style. This allows the designer greater freedom when designing outer shapes f vehicles.

The beam according to the invention may furthermore have at least any one of the following features:

the absorbers project from a rear face of the crossbar,

the absorbers extend opposite a rear face of the crossbar,

the absorbers are made of composite material,

the material of the absorbers comprises a plastic reinforced with glass fibers,

the crossbar has a profiled shape with a closed cross section,

the cross section has a rectangular or trapezoidal shape,

the cross section has an inner wall,

the absorbers are screwed to the crossbar,

the absorbers are integrally formed on the crossbar,

said material of the crossbar being an inner material, the crossbar comprises an outer layer formed of the material of the absorbers,

the outer layer covers all of the inner material,

each absorber comprises a frustoconical body,

each absorber comprises two flat devises parallel to an axis of the body and contiguous to the body,

the devises project from the body along the axis of the body and are in contact with two faces of the crossbar, the body being in contact with a third face of the crossbar,

each absorber has a number of cells,

the cells form ducts which are parallel to one another,

the ducts extend perpendicular to a longitudinal direction of the crossbar,

the ducts are vertical in the mounted position of the beam,

the cells are open at one end,

the cells have a profiled shape with a rectangular or trapezoidal cross section,

the cells are arranged in rows and columns,

the absorbers project from and/or extend opposite two respective ends of the crossbar in a longitudinal direction of the crossbar,

the absorbers cover the two ends,

each absorber has an insert that penetrates into the crossbar, in particular via an axial end of the crossbar, and

the material of the crossbar is a metal, for example steel or aluminum.

There is also provided according to the invention a bumper for a vehicle, comprising a beam according to the invention. Preferably, the bumper will also comprise a skin and a compressible element located between the skin and the beam.

There is also provided according to the invention a vehicle chassis comprising two side rails, one crossbar and two shock absorbers that are attached to the crossbar, fixed to the side rails and formed in a material that is different from the material of the crossbar, the absorbers being made of synthetic material.

Finally, there is provided according to the invention a method of producing a bumper beam comprising one crossbar and two shock absorbers that are formed in a material that is different from a material of the crossbar, in which the absorbers are attached to two respective portions of the crossbar, the absorbers being made of synthetic material.

The method may also have at least any one of the following features:

the beam is produced by extrusion,

the absorbers are integrally formed on the crossbar, and

the entire crossbar is covered with a material identical to that of the absorbers.

Other features and advantages of the invention will become apparent from the following description of four embodiments given by way of non-limiting examples. In the appended drawings:

FIG. 1 is a perspective view of a first embodiment of the beam according to the invention, partially showing the side rails of the vehicle to which it is attached;

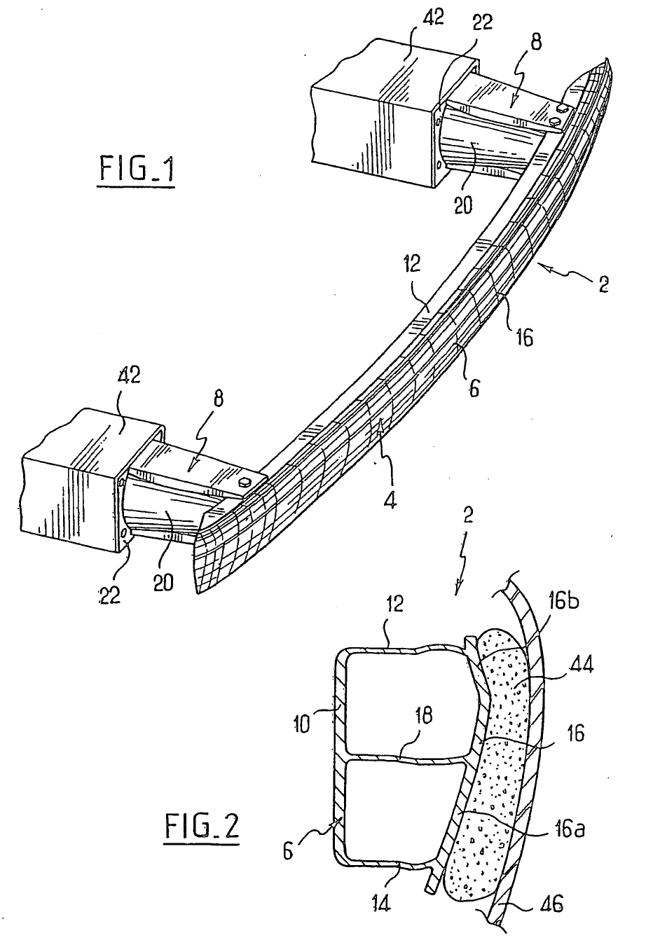

FIG. 2 is a view in cross section of a bumper incorporating the beam of FIG. 1;

FIG. 3 is a perspective view of one of the absorbers of the beam of FIG. 1;

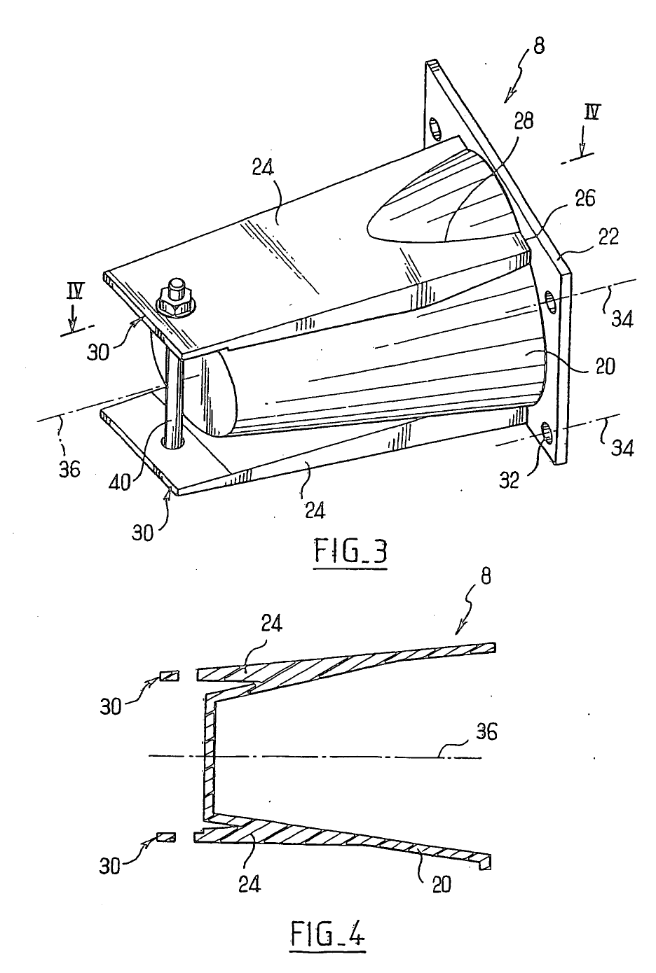

FIG. 4 is a view in section on IV-IV of the absorber of FIG. 3, with the screw having been removed;

FIG. 5 is a view similar to FIG. 1, showing a second embodiment;

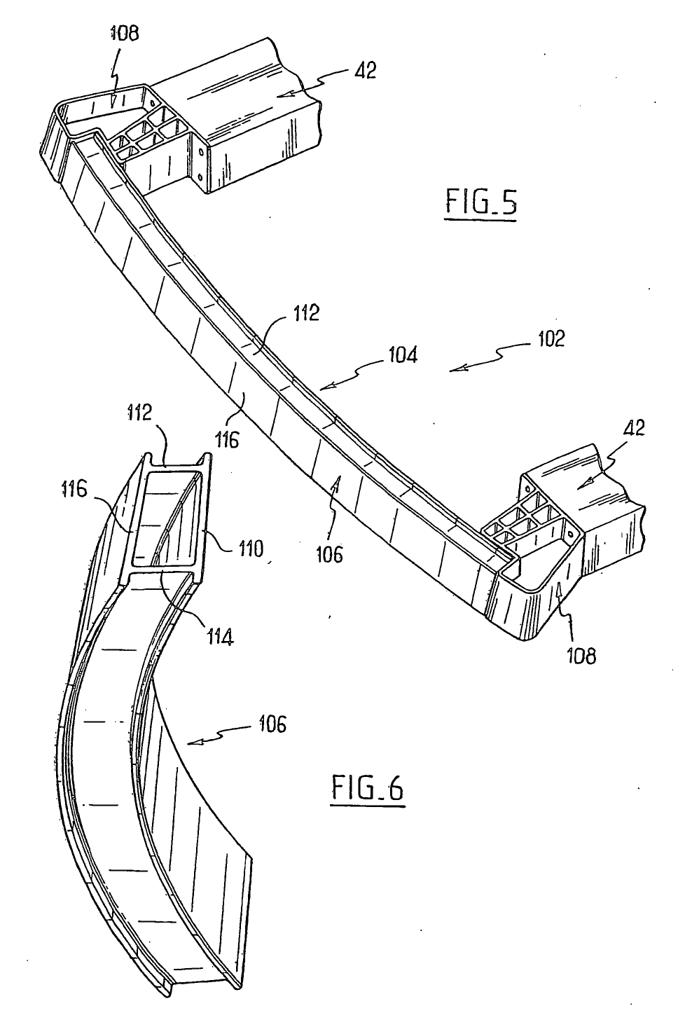

FIG. 6 is a perspective view of the crossbar of the beam of FIG. 5;

FIG. 7 is a perspective view from above of the left-hand end of the beam of FIG. 5;

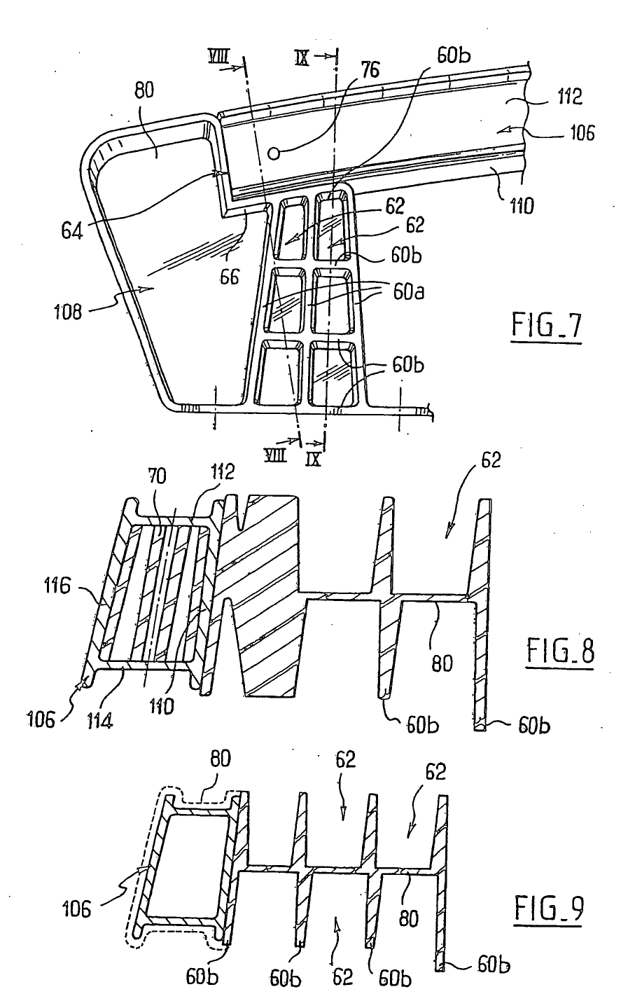

FIGS. 8 and 9 are two views in cross section of the beam of FIG. 7, on VIII-VIII and IX-IX; and

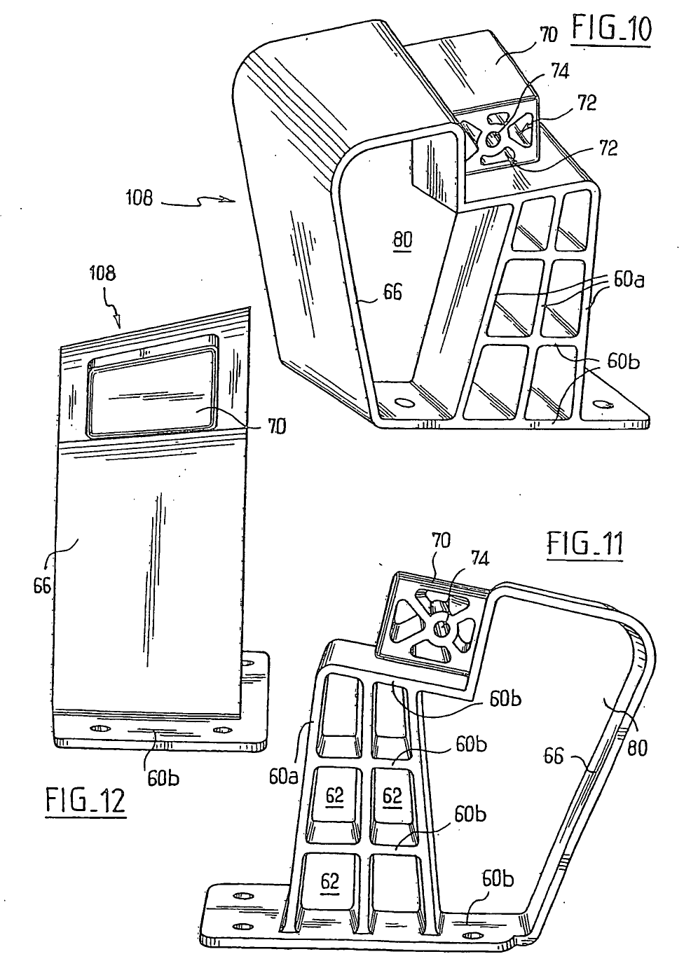

FIGS. 10, 11 and 12 are, respectively, a perspective view from above, a perspective view from below and a side view of the absorber of FIG. 7.

FIGS. 1 to 4 show a first embodiment of the bumper according to the invention. The bumper 2 comprises a beam 4 comprising one crossbar 6 and two shock absorbers 8 or “crash boxes”. The crossbar 6 is designed to extend horizontally and transversely to the direction of travel of the vehicle. The bumper may be a front bumper or a rear bumper. The crossbar has an elongated overall shape that is slightly curved in the horizontal plane, the center of curvature being on the vehicle side.

The crossbar has a profiled shape. In cross section, the profile of the crossbar is closed as shown in FIG. 2. The shape of this profile is usually rectangular or, as is the case here, trapezoidal. The crossbar comprises a vertical rear wall 10 with a straight profile, an upper wall 12 with an essentially horizontal straight profile, and a lower wall 14 with an essentially horizontal straight profile parallel to the upper wall 12, these two walls being perpendicular to the rear wall 10. The crossbar has a front wall shaped in profile by two essentially straight segments 16a, 16b that are inclined with respect to one another, the lower segment 16a taking up most of the height and being inclined downward whereas the upper segment 16b is inclined upward and extends over a smaller height. The front wall 16 extends from the upper wall 12 to the lower wall 14. Moreover, the crossbar comprises a horizontal intermediate wall 18 that is essentially planar and extends at mid-height between the upper 12 and lower 14 walls from the rear wall 10 to the front wall 16. It is possible for at least one of the horizontal walls 12, 18 and 14 to have a slight waviness, which reduces its resistance in the event of impact. In FIG. 2, the three walls have this waviness. The crossbar 6 is made of metal, preferably of aluminum or steel.

With reference in particular to FIGS. 3 and 4, each absorber 8 comprises a body 20 of frustoconical shape. The absorber comprises a plate 22 of rectangular shape that is fixed at the end of the body 20 corresponding to the widest cone section. The plate 22 is perpendicular to the axis 36 of the cone. The absorber 8 also comprises two devises 24 of essentially trapezoidal flat shape. Each clevis is fixed by one side 26 to the plate 22. This side 26 has a cutout 28 in the shape of a parabola which gives the clevis a fork-like overall shape. The two devises 24 extend parallel to one another and at a distance from one another on either side of the body 20. Each fork 28 is fixed to the body 20. The plate 22 forms the rear end of the absorber. Each clevis 24 has a front edge 30 that lies opposite the rear edge 26 and projects from the front end of the body 20 in the direction of the axis 36. The plate 22 has orifices 32 having axes 34 parallel to the axis 36 of the cone.

The absorbers 8 are made, by molding, of synthetic material, preferably of composite material. This will advantageously be a material comprising a plastic reinforced with glass fibers, such as the material known as RTS (Reinforced Thermoplastic Sheet). Such a material, which is well known per se, is prepared from a stack comprising, alternately, layers of polypropylene and layers of glass fibers. This stack is heated and compressed to form a contiguous plate. It is plates such as these which are introduced into the mold for the purpose of producing each absorber 8.

The bumper which has just been described is produced in the following manner. The absorbers 8 are produced as mentioned above. Furthermore, the crossbar 6 is produced by extruding metal through a suitably shaped die. The profiled part thus obtained is sintered to give the crossbar its overall shape and the ends are finished.

The height of the crossbar from the upper face of the upper wall 12 to the lower face of the lower wall 14 essentially corresponds to the distance between the two front ends 30 of the devises 24. It is therefore possible to place each absorber 8 astride the crossbar 6. In this position shown in FIG. 1, the crossbar extends between the two devises, the rear wall 10 of the crossbar being in contact with the front end of the body 20. One or two orifices are provided on the front end of each clevis and also at each relevant location on the crossbar for the passage of a screw 40 which is designed to pass vertically through the entire height of the assembly by extending through the upper clevis 24, the upper wall 12, the intermediate wall 18, the lower wall 14 and the lower clevis 24. In this way, each of the absorbers is rigidly fixed to the crossbar. The locations of the absorbers along the crossbar 6 are close to the respective ends of the latter. Typically, each absorber 8 will be closer to the associated end than to the center of the crossbar.

The absorbers 8 thus extend opposite the rear wall of the crossbar and project from the latter in a direction perpendicular to the longitudinal direction of the crossbar. The axes 36 of the absorbers are generally parallel to one another.

Once the beam 4 has been thus formed with the crossbar 6 and the absorbers 8, it is possible to mount said beam on the chassis of a motor vehicle. For this purpose, the plate 22 of each absorber is fixed to a respective one of the two side rails 42 of the vehicle which extend horizontally from the front to the back in the direction of travel of the vehicle, parallel to one another and at a distance from one another. The absorbers are fixed to the ends of the side rails by means of screws which pass through the orifices 32.

The bumper also comprises a compressible element 44 which extends in front of the front wall 16 of the crossbar and in contact with the latter. It also conventionally comprises a skin 46 that is made of plastic or composite material and extends in front of the compressible element 44 so as to hide both this element and the beam and absorbers from view, as seen from outside the vehicle.

Another embodiment is shown in FIGS. 5 to 11. In said embodiment, elements that are similar to those of the first embodiment bear reference numbers increased by 100.

Here again, the bumper 102 comprises a beam 104 as well as a compressible element and a skin, the latter two being identical to those of the first embodiment and not having been shown. The beam 104 comprises a crossbar 106 and two absorbers 108.

The crossbar 106 is of curved elongated shape and has a cross section of closed rectangular shape with no intermediate wall. Moreover, in this embodiment, the front 116 and rear 110 walls extend upward and downward beyond the upper 112 and lower 114 walls, as shown in FIG. 6.

Instead of the body and the clevises, each absorber 8 has ribs 60 which form a network of cells 62. In the present example, the cells 62 of each absorber are formed by ducts having their axes parallel to one another and perpendicular to the general direction of the crossbar. In the present case, the cells 62 are vertical when the bumper is in its mounted position on the vehicle. Each absorber comprises in the present case three vertical flat ribs 60a that extend essentially from the front to the rear in the direction of travel of the vehicle and four vertical flat ribs 60b that extend in a direction essentially parallel to the crossbar so as to form a grid or a network with the aforementioned ribs 60a. The ribs 60b which are respectively foremost and rearmost connect between them the front and rear ends of the ribs 60a. The two other ribs 60b constitute intermediate ribs. These ribs thus form, in plan view, a network of six cells 62 which form, as shown in FIG. 7, two columns of three cells and three rows of two cells, the rows extending parallel to the crossbar. Each cell has, in plan view, an essentially rectangular or trapezoidal shape.

Each absorber is designed to be attached to the crossbar essentially at the same location as the absorbers of the first embodiment. In the present case, the ends 64 of the crossbar 6 are perpendicular to the longitudinal direction of the crossbar. The cells extend in the place of the cone and devises of the first embodiment. Each absorber also comprises a wall 66 that extends from the front rib 60b along the rear wall 110 of the crossbar, in surface contact with the latter, and then bends and extends toward the front so as to completely cover the corresponding end 64 of the crossbar. Once it has reached the front wall 116 of the crossbar, the wall 66 bends again so as to extend in the continuation of the crossbar in the longitudinal direction of the latter. It then bends again so as to extend in a straight line obliquely both toward the rear and toward the absorber and reconnect with the rearmost rib 60b, the latter being extended in its plane beyond the cells.

Each absorber 108 comprises an intermediate wall 80 that is parallel to the walls 112 and 114 of the crossbar and extends throughout the absorber both in the cells 62 and opposite the associated end of the crossbar.

Each absorber 108 furthermore comprises an insert 70 which is shown in particular in FIGS. 10 to 12. This insert has a parallelepiped overall shape. It has a profile which allows it to penetrate into the end of the crossbar 106 so as to form a male/female assembly with the latter. The insert 70 is fixed to the zone of the wall 66 that covers the end 64 of the crossbar. This insert has recesses 72 formed by ducts that are essentially parallel to the cells 62 and open at their two ends. It also has, at its center, a duct 74 for receiving a fixing screw, as will be seen below.

As in the previous embodiment, the crossbar 106 is made of metal whereas the absorbers are made of composite material by molding. In order to mount the absorbers on the beam, the inserts 70 are introduced into the respective ends of the crossbar in accordance with a male/female assembly. A screw 76 is then introduced into orifices in the crossbar which have been made beforehand so as to extend in coincidence with the duct 74 of the insert, the screw passing through the upper wall 112 of the crossbar and then the duct 74 of the insert and finally the lower wall 114 of the crossbar. This screw is immobilized in a suitable manner by means of a nut.

The rear rib 60b of each absorber performs a similar function to that of the plates 22 of the previous embodiment. Thus, it is by means of this rib that each absorber 108 is fixed to the front end of the side rails 42 of the vehicle. It can therefore be seen, in this case too, that the absorbers are mounted on the crossbar by screwing and that the connection to the structure of the vehicle is made by screwing the absorbers to the side rails.

In a third embodiment of the invention, the absorbers 108 have a shape similar to that of the second embodiment but are integrally formed on the ends of the crossbar 106. Consequently, a layer 80 of a material identical to the material of the absorbers covers the outside of the ends of the crossbar 106. This layer has been shown in dashed line in FIG. 9. To produce the beam, the crossbar 106 is placed in the mold for producing the absorbers and the latter are integrally formed on the ends.

In a fourth embodiment of the invention, it may be provided that the entire crossbar 106 is covered with a layer of material 80 that is identical to the material of the absorbers, as shown in FIG. 9.

In each of these embodiments, the closed shape of the cross section of the crossbar gives it sufficient rigidity to deform the test barrier during the high speed impact compatibility test and to successfully pass this test. The absorbers provided with a body of frustoconical shape make it possible to achieve a gain in terms of weight compared to absorbers made of steel. Moreover, they have a compression ratio that is greater than that of steel absorbers. These absorbers make it possible to absorb the energy in a “reparability” impact.

In the second embodiment, the absorbers 108 also absorb the energy during a reparability test and also protect the ends of the crossbar. Because they cover these ends and project from the latter in the direction of the crossbar, they can deform in the event of a side impact and absorb the energy of the impact. The beam therefore responds better in the event of a corner impact. Such a corner impact forms part of the parking impact specifications. In this embodiment, the weight gain is even greater than in the first embodiment. Moreover, the crossbar may have a simpler shape than in the first embodiment for the purpose of simplifying extrusion thereof.

In the third embodiment, the absorbers may be integrally formed by compression or injection molding on the ends of the crossbar. This embodiment has the advantage that it does not require parts assembly.

In the four embodiments, the crossbar may be made of aluminum, steel or of thermosetting or thermoplastic composite material. The absorbers may also be at least partly made of the material known as EMIR. In this material, the glass fibers reinforcing the plastic are arranged in a glass fiber mat.

Of course, many modifications may be made to the invention without departing from the scope thereof. There may be provided a bumper beam for a vehicle which comprises one crossbar and two shock absorbers that are attached to respective portions of the crossbar, the crossbar having a closed profile in cross section, independently of considerations concerning the materials of the crossbar and of the absorbers.

In the foregoing text, the screw fixings may be replaced by other fixing methods.

1. A bumper (2) beam (4; 104) for a vehicle, comprising one crossbar (6; 106) and two shock absorbers (8; 108) that are attached to two respective portions of the crossbar and are formed in a material that is different from a material of the crossbar, characterized in that the absorbers are made of synthetic material.

2. The beam as claimed in claim 1, characterized in that the absorbers (8; 108) project from a rear face (10; 110) of the crossbar (6; 106).

3. The beam as claimed in either of claims 1 and 2, characterized in that the absorbers (8; 108) extend opposite a rear face (10; 110) of the crossbar.

4. The beam as claimed in any of claims 1 to 3, characterized in that the absorbers (8; 108) are made of composite material.

5. The beam as claimed in any of claims 1 to 4, characterized in that the material of the absorbers comprises a plastic reinforced with glass fibers.

6. The beam as claimed in any of claims 1 to 5, characterized in that the crossbar (6; 106) has a profiled shape with a closed cross section.

7. The beam as claimed in claim 6, characterized in that the cross section has a rectangular or trapezoidal shape.

8. The beam as claimed in any of claims 1 to 7, characterized in that it has an inner wall (18).

9. The beam as claimed in any of claims 1 to 8, characterized in that the absorbers (8; 108) are screwed to the crossbar (6; 106).

10. The beam as claimed in any of claims 1 to 9, characterized in that the absorbers (108) are integrally formed on the crossbar (106).

11. The beam as claimed in any of claims 1 to 10, characterized in that, said material of the crossbar (106) being an inner material, the crossbar comprises an outer layer (80) formed of the material of the absorbers (108).

12. The beam as claimed in claim 11, characterized in that the outer layer (80) covers all of the inner material.

13. The beam as claimed in any of claims 1 to 12, characterized in that each absorber (8) comprises a frustoconical body (20).

14. The beam as claimed in claim 13, characterized in that each absorber (8) comprises two flat devises (24) parallel to an axis (36) of the body and contiguous to the body.

15. The beam as claimed in claim 14, characterized in that the Devises (24) project from the body along the axis (36) of the body and are in contact with two faces (12, 14) of the crossbar (6), the body being in contact with a third face (10) of the crossbar.

16. The beam as claimed in any of claims 1 to 15, characterized in that each absorber (108) has a number of cells (62).

17. The beam as claimed in claim 16, characterized in that the cells (62) form ducts which are parallel to one another.

18. The beam as claimed in claim 17, characterized in that the ducts extend perpendicular to a longitudinal direction of the crossbar.

19. The beam as claimed in claim 17 or 18, characterized in that the ducts are vertical in the mounted position of the beam.

20. The beam as claimed in any of claims 16 to 19, characterized in that the cells (62) are open at one end.

21. The beam as claimed in any of claims 16 to 20, characterized in that the calls (62) have a profiled shape with a rectangular or trapezoidal cross section.

22. The beam as claimed in any of claims 16 to 21, characterized in that the cells (62) are arranged in rows and columns.

23. The beam as claimed in any of claims 1 to 22, characterized in that the absorbers (108) project from two respective ends (64) of the crossbar (106) in a longitudinal direction of the crossbar.

24. The beam as claimed in any of claims 1 to 23, characterized in that the absorbers (108) extend opposite two respective ends (64) of the crossbar (106) in a longitudinal direction of the crossbar.

25. The beam as claimed in claim 23 or claim 24, characterized in that the absorbers (108) cover the two ends.

26. The beam as claimed in any of claims 1 to 25, characterized in that each absorber (108) has an insert (70) that penetrates into the crossbar (106), in particular via an axial end of the crossbar.

27. The beam as claimed in any of claims 1 to 26, characterized in that the material of the crossbar (6; 106) is a metal, for example steel or aluminum.

28. A bumper (2) for a vehicle, characterized in that it comprises a beam as claimed in any of claims 1 to 27.

29. The bumper as claimed in claim 28, characterized in that it also comprises a skin (46).

30. The bumper as claimed in claim 29, characterized in that it also comprises a compressible element (44) located between the skin (46) and the beam (6).

31. A vehicle chassis comprising two side rails (42), one crossbar (6; 106) and two shock absorbers (8; 108) that are attached to the crossbar, fixed to the side rails and formed in a material that is different from a material of the crossbar, characterized in that the absorbers are made of synthetic material.

32. A method of producing a bumper beam (4; 104) comprising one crossbar (6; 106) and two shock absorbers (8; 108) that are formed in a material that is different from a material of the crossbar, in which the absorbers are attached to two respective portions of the crossbar, characterized in that the absorbers are made of synthetic material.

33. The method as claimed in claim 32, characterized in that the beam (4; 104) is produced by extrusion.

34. The method as claimed in either of claims 32 and 33, characterized in that the absorbers (108) are integrally formed on the crossbar (106).

35. The method as claimed in any of claims 32 to 34, characterized in that the entire crossbar (106) is covered with a material identical to that of the absorbers (108).
